(19) United States
(12) Patent Application Publication
(10) Pub. No.: US 2024/0376387 A1
(43) Pub. Date: Nov. 14, 2024

(54) Electrifield stream-methane-reforming reactor and methods of use

(71) Applicant: Infinium Technology, LLC, Sacramento, CA (US)

(72) Inventors: Robert Schuetzle, Sacramento, CA (US); Glenn McGinnis, Sun Lakes, AZ (US); Orion Hanbury, Sacramento, CA (US); Matthew Caldwell, West Sacramento, CA (US); Ramer Rodriguez, Sacramento, CA (US)

(21) Appl. No.: 18/445,178

(22) Filed: May 9, 2023

(51) Int. Cl. C10G 2/00; B01J 19/24; C01B 3/12; C01B 3/40

(52) U.S. Cl. CPC C10G 2/30; B01J 19/2415; B01J 19/245; C01B 3/12; C01B 3/40; B01J 2219/00132; C01B 2203/0233; C01B 2203/0283; C01B 2203/062; C01B 2203/085; C01B 2203/1058; C10G 2400/04

(57) ABSTRACT

The present disclosure describes systems and methods for producing eFuels or chemicals such as sustainable aviation fuel, renewable diesel, methanol, and ammonia, as well as the synthesis of oxygenated and non-oxygenated chemical feedstocks. Electrolyzers, CO2 capture devices, Reverse Water Gas Shift (RWGS) reactors, syngas conversion reactors, and electrical steam methane reformers (eSMR) are used to produce eFuel.

### FIELD OF THE INVENTION

The field of the invention is systems and methods for producing eFuels or chemicals from renewable or low-carbon electricity and the methods for controlling such processes.

### BACKGROUND OF THE INVENTION

Carbon dioxide is produced by many industrial and biological processes. Carbon dioxide is usually discharged into the atmosphere. However, since carbon dioxide has been identified as a significant greenhouse gas, carbon dioxide emissions need to be reduced from these processes. One such industrial process is the production of electrical power. Electrical power is increasingly being produced from renewable sources such as solar and wind which do not emit CO₂ and can sometimes be produced more cost effectively than power produced from fossil fuels.

However, while electrical power can be produced in a sustainable manner, there remains a need for fuels and chemicals that are produced with low, zero or negative CO₂ emissions. In some cases, this need can be fulfilled using eFuels that are made by storing electrical energy from renewable sources in the chemical bonds of liquid or gas molecules. eFuels can be a drop-in alternative to aviation (e.g., jet, also called sustainable aviation fuel or SAF) fuel, diesel fuel, gasoline, butanol, naphtha, synthetic natural gas, or other fuel products that are otherwise produced from fossil fuels. Furthermore, potential chemicals that can be produced using renewable power include ammonia, methanol, as well as high value-added chemicals such as formaldehyde, acetic acid, acetic aldehyde, waxes, or lower olefins and aromatic compounds (e.g., as starting materials for fine chemical production). This category of eFuel production processes can be referred to as “Power-to-X”, referring to renewable power being a primary input in producing X, where X is fuels, chemicals, natural gas, and the like.

Production of eFuels and chemicals can require a feedstock in addition to the electrical power. In some cases, this feedstock can include carbon, e.g., derived from CO₂ captured from other industrial sources, which CO₂ would otherwise be emitted into the atmosphere. In some cases, this feedstock can include nitrogen derived from a number of sources including air separation units. Some eFuels or chemicals can be “carbon-negative”, i.e., consuming more CO₂ than they emit in the overall evaluation of the well-to-wheels carbon emissions including emissions from the production process. Water. can be another feedstock to an eFuel or chemical process, which can be electrolyzed using renewable power to produce oxygen (O₂) and hydrogen (H₂).

eFuels or electrofuels refers to the production of synthetic fuels from waste CO2 that would otherwise be emitted to the atmosphere and low carbon hydrogen, traditionally produced from renewable power that is used to produce hydrogen using electrolysis. F-T processes or the Direct LFP process described herein can be used in the production of fuels in an eFuels process.

eFuel production using Power-to-X utilizes renewable power as a primary input and therefore this input typically comprises the largest part of the operating expense of an eFuels or other Power-to-X plant operating costs. A secondary cost may be additional feedstocks, such as CO2, nitrogen, water, or other inputs.

Various Power-to-X (PtX) concepts depend on the utilization of renewable or low-carbon electricity to produce hydrogen through the electrolysis of water. This hydrogen can be used directly as a final energy carrier or it can be converted into, for example, methane, synthesis gas, liquid fuels, electricity, or chemicals. Technical demonstration and systems integration are of major importance for integrating PtX into energy systems.

### BRIEF SUMMARY OF THE INVENTION

The present disclosure describes systems and methods for producing eFuels or chemicals such as sustainable aviation fuel (SAF), diesel, methanol, ammonia, and the synthesis of oxygenated and non-oxygenated chemical feedstocks. Electrolyzers, CO₂ capture devices, Reverse Water Gas Shift (RWGS) reactors, syngas conversion reactors, and electrical steam methane reformers (eSMR) are used to produce eFuel.

In an aspect, provided herein is a method for controlling a process that produces eFuels including the use of an electrical steam methane reformer (eSMR). The method can include providing a first amount of electrical power to an electrolysis module to produce H₂, separately heating the H₂ and CO₂ streams, mixing the H₂ with CO₂ to provide a gas mixture having a first ratio of H₂ to CO₂, performing a reverse water gas shift reaction on the gas mixture to produce synthesis gas, and reacting the synthesis gas to produce a liquid hydrocarbon or other PtX product. The method can further include, in response to a stimulus, providing a second amount of electrical power to the electrolysis module to produce H₂, mixing the H₂ with CO₂ to provide a gas mixture having a second ratio of H₂ to CO₂, performing a reverse water gas shift reaction on the gas mixture to produce synthesis gas, and reacting the synthesis gas to produce a liquid hydrocarbon. The second amount of electrical power is a value between zero and the value of the first amount of electrical power. The second ratio of H₂ to CO₂ is substantially similar to the first ratio of H₂ to CO₂.

In some embodiments, the H₂ is produced by the electrolysis module and stored.

In some embodiments, H₂ is recovered from a product stream of the reaction of synthesis gas to the liquid hydrocarbon or other PtX products.

In some embodiments, the H₂ is recovered using pressure swing adsorption.

In some embodiments, the second amount of electrical power is an amount between 0% and 70% of the first amount of electrical power.

In some embodiments, an amount of electrical power delivered to a reactor performing the water gas shift reaction is reduced by an amount which is an amount between 0% and the ratio of the second amount of electrical power to the first amount of electrical power.

In some embodiments, the flowrate of the gas mixture is reduced by an amount between 20% and 100%.

In some embodiments, the first and/or second amounts of electrical power are derived from renewable resources.

In some embodiments, the liquid hydrocarbon is a fuel.

In some embodiments, the first ratio and the second ratio are between 2.0 and 4.0.

In another aspect, provided herein is a system for producing eFuel. The system can include an electrolysis module that uses electrical power to convert water into an electrolysis product stream comprising H₂. The system can include a reverse water gas shift module that reacts CO₂ with the electrolysis product stream to produce a synthesis gas mixture comprising CO. The hydrogen recovery module is recovers H₂ from the synthesis gas mixture to produce (i) a H₂ stream which is directed to the reverse water gas shift module and (ii) a synthesis gas mixture that is depleted in H₂. The system can further include a hydrocarbon synthesis module that converts the synthesis gas mixture that is depleted in H₂ into a liquid hydrocarbon and an electrified steam-methane-reforming (eSMR) reactor reacts (i) unreacted reactants from the hydrocarbon synthesis module and (ii) hydrocarbons having on average fewer than 5 carbon atoms from the hydrocarbon synthesis module to produce an eSMR product stream that is fed to the hydrocarbon synthesis module and optionally (iii) O₂ from the electrolysis module. In one embodiment, oxygen produced by the electrolyzer can be used as a feed to the eSMR. A hydrocarbon synthesis module is a unit that produces a synthetic fuel from a feed comprising hydrogen and carbon monoxide. An example of a hydrocarbon synthesis module is a liquid fuel production unit (LFP).

In one embodiment, the eSMR uses AC or DC power and direct electrical resistance to heat the reactors. In another embodiment, the eSMR uses traditional resistance heaters on the outside of tubes to provide the heat. Unlike a conventional SMR, the electrified process supplies heat uniformly across the reactor. The integrated heating allows for exceptionally compact reactor designs.

In some embodiments, the sensor detects a ratio of H₂ to CO₂ in the input to the reverse water gas shift module.

In some embodiments, the stimulus is a ratio of H₂ to CO₂ in the input to the reverse water gas shift module is an amount between 0 and 2.5.

In some embodiments, the hydrogen recovery module comprises a pressure swing adsorber (PSA).

In some embodiments, compared with the hydrogen recovery module not being operated, operation of the hydrogen recovery module increases a ratio of H₂ to CO being fed to the hydrocarbon synthesis module.

In this specific embodiment, the electrical heaters for the RWGS reactor are not used to raise the temperature as some of the oxygen will be used for combustion of the RWGS feed gases to heat the remainder of the feed gases.

It should be appreciated that all combinations of the foregoing concepts and additional concepts discussed in greater detail below (provided such concepts are not mutually inconsistent) are contemplated as being part of the inventive subject matter disclosed herein. In particular, all combinations of subject matter within this disclosure are contemplated as being part of the inventive subject matter disclosed herein.

Still other aspects, examples, and advantages of these exemplary aspects and examples, are discussed in detail below. Moreover, it is to be understood that both the foregoing information and the following detailed description are merely illustrative examples of various aspects and examples and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF THE DRAWING

FIG. 1 shows an example of a process for the production of eFuels from renewable power and CO₂.

FIG. 2 shows an example of a process for temporarily recycling hydrogen from the effluent back to the input of a reverse water-gas-shift module.

FIG. 3 shows an example of a process for recovering and recycling hydrogen in an eFuel process.

### DETAILED DESCRIPTION OF THE INVENTION

As renewable power becomes more economical and more widely deployed, chemical processes that store solar, wind, hydro, nuclear or other forms of renewable or low carbon power in chemical bonds (i.e., eFuels, chemicals and other Power to X (PtX) products) such as the ones described herein become more attractive.

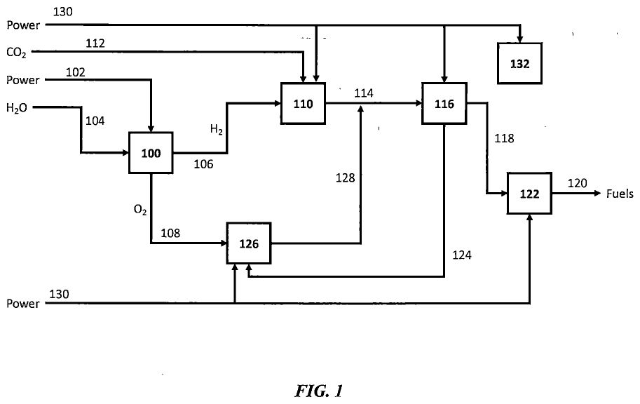

One such advantageous process for producing fuels and chemicals is described herein and depicted schematically in FIG. 1. Overall, this process converts power, CO₂ and water into fuels and chemicals. Here, an electrolyzer 100 can use power 102 to convert water 104 into hydrogen 106 and oxygen 108. The hydrogen can be fed to a reverse water-gas-shift module 110 to be combined with CO₂ 112 to produce synthesis gas (syngas) 114 comprising carbon monoxide (CO) and hydrogen. The syngas can be reacted in a liquid fuel production module or other module that produces the end product 116 to produce liquid hydrocarbons or another PtX product 118, which can be separated into fuel and chemical products 120 in a fractionation module 122. The productivity of the process can be improved by taking the tail gas 124 from the liquid fuel production module to an eSMR reforming module 126 to be optionally reacted with oxygen 108 to produce additional syngas feedstock 128 for the liquid fuel production module.

The system depicted in FIG. 1 reduces the overall power requirements and the size of the capital-intensive electrolysis module and can be more readily turned down than competing processes for producing liquid fuels and chemicals because a large fraction of the overall power consumption of the process goes to 102 the electrolyzer 100. Additional power 130 can go to utilities 132 or modules other than the electrolyzer (e.g., reverse water-gas-shift, liquid fuel production, fractionation, eSMR reformer). However, these are typically much smaller than the amount of power that is dedicated to electrolysis. In some cases, an amount between 50% and 100% of the total power consumed by the process is consumed by the electrolyzer.

In some cases, the output of the process is kept as high as possible given a decrease (i.e., turn down) of an amount of an input to the process (e.g., power). The process can be turned down in a manner that maintains the ability to turn the process back up quickly with minimal disruption. For example, reactors can be kept at or near production temperatures and pressures. Such is the case here, with reference to FIG. 1, power can be maintained to most or all of the process 130 except for the electrolyzer 102. Overall, with respect to power consumption, the process can be turned down by 10% to 100%.

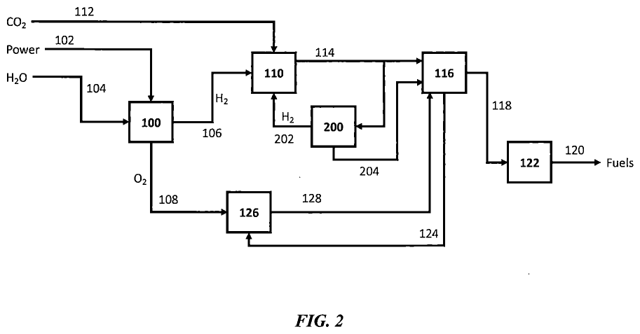

The process can be improved or modified to maintain as much productivity as possible at a given level of turn down with respect to power consumption. For example, FIG. 2 shows a hydrogen recovery module 200 which takes the syngas product 114 from the reverse water-gas-shift module 110 and separates hydrogen. The hydrogen 202 can be returned to the reverse water-gas-shift module to supplement hydrogen that is provided directly from the electrolyzer 106.

The hydrogen recovery module 200 can be operated in a turndown case to maintain a suitable amount of hydrogen being fed to the reverse water-gas-shift module, which operates with a stoichiometric excess of excess hydrogen. The process can be turned down in response to a stimulus. The system can include a controller capable of controlling the hydrogen recovery module in response to the stimulus. The hydrogen recovery module is capable of recovering H2 from the synthesis gas mixture to produce (i) a H2 stream 202 which is directed to the reverse water gas shift module 110 and (ii) a synthesis gas mixture that is depleted in H2 204, which can be sent to liquid fuel production 116.

As in FIG. 1, 102 is the power supply, 104 is water, 108 is oxygen, 112 is CO₂, 118 is the liquid hydrocarbon product, 120 is the product fuel or chemicals, 122 is a fractionation module, 124 is the tail gas, 126 is the eSMR module.

Hydrogen can be recovered and recycled to the reverse water-gas-shift module in any suitable way. In some cases, hydrogen is recovered with the assistance of a selective membrane. The hydrogen recovery module can comprise a pressure swing adsorber (PSA).

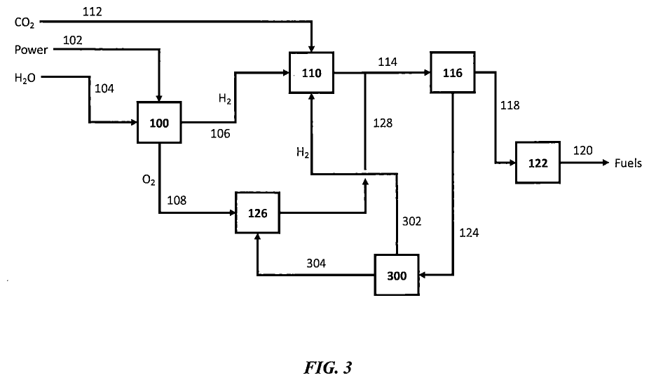

FIG. 3 shows another system for managing hydrogen. In an aspect, a system is provided for producing an eFuel. The system can include an electrolysis module that uses electrical power to convert water into an electrolysis product stream comprising H₂. The system can further include a reverse water gas shift module that reacts CO₂ with the electrolysis product stream to produce a synthesis gas mixture comprising CO and H₂. The system can further include a hydrocarbon synthesis module that converts the synthesis gas mixture into a liquid hydrocarbon. The system can further include a hydrogen recovery module that recovers H₂ from the hydrocarbon synthesis module and feeding said H₂ to the reverse water gas shift module.

The system can further include an eSMR reactor that reacts (i) unreacted reactants from the hydrocarbon synthesis module and/or the hydrogen recovery module and (ii) hydrocarbons having on average fewer than 5 carbon atoms (meaning that some constituents in the stream have a higher carbon numbers, but on average the hydrocarbons in this stream have fewer than 5 carbon atoms) from the hydrocarbon synthesis module and/or the hydrogen recovery module to produce an eSMR product stream that is fed to the hydrocarbon synthesis module and Liquid Fuel Production (LFP) system. In one embodiment, the liquid fuels produced by the LFP have 51-100 mole % C5-C24. In one embodiment, the liquid fuels produced by the LFP have 60-100 mole % C5-C-24. In one embodiment, the liquid fuels produced by the LFP have 80-100 mol % C5-C24.

Optionally O₂ from the electrolysis module will help to keep the electrical power input to the eSMR down.

With reference to FIG. 3, hydrogen in the tail gas 124 can be recovered in a hydrogen recovery module 300 to produce (i) a H₂ stream 302 which is directed to the reverse water gas shift module 110 and (ii) a tail gas mixture that is depleted in H₂ 304, which can be sent to the eSMR reformer 126. Hydrogen can be recovered and recycled to the reverse water-gas-shift module in any suitable way. In some cases, hydrogen is recovered with the assistance of a selective membrane. The hydrogen recovery module can comprise a pressure swing adsorber (PSA).

As in FIG. 1, 102 is the power supply, 104 is water, 106 is hydrogen, 108 is oxygen, 112 is CO₂, 114 is the syngas product, 116 is the liquid fuel production module, 118 is the liquid hydrocarbon product, 120 is the product fuel or chemicals, 122 is a fractionation module.

There are numerous ways that the electrical heating of the feed gas to the eSMR can be done. One way is using an electrically heated radiant furnace. In this embodiment, at least a portion of the feed gas passes through a heating coil in a furnace. In the furnace, the heating coil is surrounded by radiant electric heating elements. In another embodiment of the invention, the gas is passed directly over heating elements whereby the gas is heated by convective heat transfer. The electric heating elements can be made from numerous materials. The most common heating elements are nickel chromium alloys. These elements may be in rolled strips or wires or cast as zig zag patterns. The elements are fixed into an insulated vessel where ceramic fiber is generally used for insulation. The radiant elements may be divided into zones to give a controlled pattern of heating. Multiple coils and multiple zones may be needed to provide the energy to produce a heated feed gas. Radiant furnaces require proper design of the heating elements and fluid coils to ensure good view factors and good heat transfer.

The radiant section of a furnace or heater is designed to provide efficient heat transfer from the burner to the process fluid flow. The radiant section typically consists of panels or tubes that are heated by burners and then radiate heat to process fluid flow. Good view factors and heat transfer are critical to the efficiency of the radiant section. The design considers several factors including the geometry of the heating elements and fluid coils, orientation of the elements, and distance between the process fluid or gas. These factors determine the view factors, which represent the portion of the radiated heat that is absorbed by the process fluid. The higher the view factor the more efficient the heat transfer. One way to ensure good view factors and heat transfer is to design the heating elements and fluid coils with a large surface area relative to the process fluid flow. This can be achieved by increasing the length and/or in the radiant section or by using panels with higher surface areas to volume ratio.

Another important factor in the radiant design is the orientation of the heating elements and fluid coils. The elements should be arranged in a way that maximizes the direct line of sight between the heating surface and the process fluid. This is achieved by arranging the tubes or panels in rows perpendicular to the flow direction, or by using spirals or helixes to increase the path length of the process fluid.

The distance between the heating elements and the process fluid or gas flow can ensure good heat transfer. If the distance is too large, the radiated heat will dissipate before reaching the process fluid. If the distance is too small, the process fluid may have enough time to absorb the heat. The optimal distance depends on the geometry and orientation of the heating elements and fluid coils and the desired heating rate and efficiency. The electricity usage by the radiant furnace should be as low as possible.

When an eSMR is used, excess hydrogen is produced from the reforming of the hydrocarbon input steam with water into syngas. In this embodiment, the size of the electrolyzer used in the overall system design may be reduced by up 5%, 10%, 25% or more preferably reduced by up to 50% therefore reducing the overall capital cost of the system by using the eSMR in this part of the system design.

In some embodiments, instead of an eSMR an autothermal reformer (ATR) may be used for this conversion step to produce additional syngas. The ATR used the oxygen from the electrolyzer as a feed stream and does not require any external heating.

In some embodiments, the flowrate of the gas mixture (i.e., of H₂ with CO₂) is reduced (i.e., amount of turn down with respect to reactant consumption). The flowrate of the gas mixture can be an amount between 0% and 70% of the flowrate of the gas mixture at full capacity of the process. In some cases, the flowrate of the gas mixture is between 0% and 70% of the flowrate of the gas mixture at full capacity of the process.

The first ratio and/or the second ratio of H₂ to CO₂ can be between 2.0 and 4.0; preferably between 2.5 and 3.5; and even more preferably between 2.8 and 3.2.

The second ratio of H₂ to CO₂ is substantially similar to the first ratio of H₂ to CO₂. In some instances, the first and second ratio differ by no more than 40%; preferably no more than 15%; and even more preferably no more than 3%.

In some embodiments, H₂ is drawn from a pipeline in response to the stimulus or from another form of low carbon hydrogen. In some embodiments, the H₂ is produced by the electrolysis module and stored. In some embodiments, H₂ is drawn from storage in response to the stimulus. In some embodiments, H₂ is recovered from a product stream of the reaction of synthesis gas to the liquid hydrocarbon. In some embodiments, the H₂ is recovered using pressure swing adsorption. In some embodiments, an amount of electrical power delivered to a reactor performing the reverse water gas shift reaction is reduced by an amount which is a value between zero and the value of the ratio of the second to the first amounts of electrical power.

Carbon dioxide can be obtained from several sources. Industrial manufacturing plants that produce ammonia for fertilizer produce large amounts of carbon dioxide. Ethanol plants that convert corn or wheat into ethanol produce large amounts of carbon dioxide. Power plants that generate electricity from various resources (for example natural gas, coal, other resources) produce large amounts of carbon dioxide. Chemical plants such as nylon production plants, ethylene production plants, and other chemical plants produce large amounts of carbon dioxide. Some natural gas processing plants produce CO₂ as part of the process of purifying the natural gas to meet pipeline specifications. Capturing CO₂ for utilization as described here often involves separating the carbon dioxide from a flue gas stream or another stream where the carbon dioxide is not the major component. Some CO₂ sources are already relatively pure and can be used with only minor treatment (which may include gas compression) in the processes described herein. Some processes may require an alkylamine or other method that would be used to remove the carbon dioxide from the flue gas steam. Alkylamines used in the process include monoethanolamine, diethanolamine, methydiethanolamine, disopropylamine, aminoethoxyethnol, or combinations thereof. Metal Organic Framework (MOF) materials have also been used as a means of separating carbon dioxide from a dilute stream using chemisorption or physisorption to capture the carbon dioxide from the stream. Other methods to get concentrated carbon dioxide include chemical looping combustion where a circulating metal oxide material captures the carbon dioxide produced during the combustion process. Carbon dioxide can also be captured from the atmosphere in what is called direct air capture (DAC) of carbon dioxide.

Renewable sources of Hydrogen (H₂) can be produced from water via electrolysis.

$${H}_{2} O = {H}_{2} + \frac{1}{2} {O}_{2}$$

This reaction uses electricity to split water into hydrogen and oxygen. Electrolyzers consist of an anode and a cathode separated by an electrolyte. Different electrolyzers function in slightly different ways, mainly due to the different types of electrolyte material involved.

However, each electrolysis technology has a theoretical minimum electrical energy input of 39.4 kWh/kg H₂ (HHV of hydrogen) if water is fed at ambient pressure and temperature to the system and all energy input is provided in the form of electricity. The required electrical energy input may be reduced below 39.4 kWh/kg H₂ if suitable heat energy is provided to the system. Besides electrolysis, significant current research is examining ways to split water into hydrogen and oxygen using light energy and a photocatalyst.

Different electrolyzer designs that use different electrolysis technology can be used including alkaline electrolysis, membrane electrolysis, polymer electrolyte membrane (PEM), solid oxide electrolysis (SOE), and high temperature electrolysis. Alkaline electrolysis is commercially capable of larger scale operation. Different electrolytes can be used including liquids KOH and NaOH with or without activating compounds can be used. Activating compounds can be added to the electrolyte to improve the stability of the electrolyte. Most ionic activators for hydrogen evolution reaction are composed of ethylenediamine (en)-based metal chloride complex ([M(en)3]Clx,M1/4Co, Ni, et al.) and Na₂MoO₄ or Na₂WO₄. Different electrocatalysts can be used on the electrodes including many different combinations of metals and oxides like Raney-Nickel-Aluminum, which can be enhanced by adding cobalt or molybdenum to the alloy. Several combinations of transition metals, such as Pt₂Mo, Hf₂Fe, and TiPt, have been used as cathode materials and have shown significantly higher electrocatalytic activity than state-of-the-art electrodes. In some embodiments, when electricity is provided to the electrolysis module, H₂ is produced at one electrode and O₂ is produced at another electrode.

Water at the cathode combines with electrons from the external circuit to form hydrogen gas and negatively charged oxygen ions. The oxygen ions pass through the solid ceramic membrane and react at the anode to form oxygen gas and generate electrons for the external circuit. In this way, both hydrogen gas and oxygen gas are produced in the electrolyzer. In one embodiment, multiple electrolyzers are operated in parallel. No electrolyzer operates with 100% energy efficiency and energy usage is critical to the economic operation of the facility. The energy usage in the electrolyzer should be between 0 and 200 mega-watthours (MWh)/metric ton (MT) of H₂ produced; preferably between 0 and 120 MWh/MT H₂ produced; and even more preferably between 0 and 60 MWh/MT H₂ produced. For the alkaline electrolyzer embodiment, the electricity usage will be greater than 39.4 MWh/MT H₂ produced. However, for the high temperature electrolyzer embodiment, the electricity usage can potentially be between 0 and 39.4 MWh/MT H₂ produced if waste heat is used to heat the electrolyzer above ambient temperature.

In some embodiments, the electricity demand can be further reduced by 10%, 20%, or even more preferably, 40% by the choice of electrolyzer used in the eFuels project. This is achieved by using a solid oxide electrolyzer (SOE). SOEs must operate at temperatures high enough for the solid oxide membranes to function properly (about 700°-800° C., compared to PEM electrolyzers, which operate at 70°-90° C., and commercial alkaline electrolyzers, which typically operate at less than 100° C.). The SOEs can effectively use heat available at these elevated temperatures to decrease the amount of electrical energy needed to produce hydrogen from water. In these embodiments the heat comes from 200 psig steam produced by the LFP unit. This creates a 6.2% decrease in the electricity requirement for the electrolyzer for every 100,000 lbs of this steam. This also reduces the total amount of water needed in the electrolyzer by 100,000 lbs for every 100,000 lbs of steam used. This creates a reduction in the overall capital costs.

In some embodiments, using 161,290 lbs of 200 psig steam from the LFP, creates a further reduction in electricity requirements by 10%. In other embodiments, using 322,581 lbs of 200 psig steam from the LFP creates a further reduction in the electricity requirements by 20%. In other embodiments, using 645,161 lbs of 200 psig steam from the LFP creates a further reduction in the electricity requirements by 40%. In all of these embodiments, the reduction in electricity requirements directly causes a reduction in capital requirements and operating costs.

As described herein, the reverse water-gas-shift (RWGS) reaction can be used to produce syngas according to the formula:

CO₂+H₂=CO+H₂O

This reaction converts carbon dioxide and hydrogen to carbon monoxide and water. This reaction is endothermic at room temperature and requires heat to proceed and elevated temperature and a good catalyst is required for significant carbon dioxide conversion.

Hydrogen and carbon dioxide are mixed. The ratio of H₂/CO₂ can be between 2.0 mol/mol to 4.0 mol/mol, in some cases between 3.0 to 4.0 mol/mol. The mixed RWGS feedstock can be heated by indirect heat exchange to a temperature of greater than 900° F. This initial temperature rise can be done without the use of direct combustion of a carbon containing gas to provide the heat. This would mean that carbon dioxide was being produced and could possibly negate the impact of converting carbon dioxide to useful fuels and chemicals.

The RWGS feed gas, comprising a mixture of hydrogen and carbon dioxide, can be heated to an inlet temperature. The inlet temperature can be any suitable temperature for performing the RWGS reaction. In some cases, the inlet temperature of the RWGS feed is between 900° F. and 1800° F.

The RWGS feed gas can be heated at least partially in a preheater outside the main reactor vessel to produce heated feed gas. In some embodiments, the CO2 and H2 feeds are heated separately either by electrical heating, gas fired heating, heat transfer (from other streams in the integrated process, or other methods). The preheater can be electrically heated and raises the temperature of the feed gas through indirect heat exchange.

There can be numerous ways that the electrical heating of the feed gas can be done. One way is through electrical heating in an electrically heated radiant furnace. In some embodiments, at least a portion of the feed gas passes through a heating coil in a furnace. In the furnace, the heating coil is surrounded by radiant electric heating elements, or the gas is passed directly over the heating elements whereby the gas is heated by some convective heat transfer. The electric heating elements can be made from numerous materials. The heating elements may be nickel chromium alloys. These elements may be in rolled strips or wires or cast as zig zag patterns. The elements are typically backed by an insulated steel shell, and ceramic fiber is generally used for insulation. The radiant elements may be divided into zones to give a controlled pattern of heating. Multiple coils and multiple zones may be needed to provide the heat to the feed gas and produce a heated feed gas. Radiant furnaces require proper design of the heating elements and fluid coils to ensure good view factors and good heat transfer. The electricity usage by the radiant furnace should be as low as possible. The electricity usage by the radiant furnace is between 0 and 0.5 MWh (megawatt-hour) electricity/metric ton (MT) of CO₂ in the feed gas; preferably between 0 and 0.40 MWh/MT CO₂; and even more preferably between 0 and 0.20 MWh/MT CO₂.

The heated RWGS feed gas stream can then be fed into the main RWGS reactor vessel. There are at least two possible embodiments of the main RWGS reactor vessel. In some embodiments, the main RWGS reactor vessel is adiabatic or nearly adiabatic and is designed to minimize heat loss, but no added heat is added to the main reactor vessel and the temperature in the main reactor vessel will decline from the inlet to the outlet of the reactor. In some embodiment, the main RWGS reactor vessel is similarly designed but additional heat is added to the vessel to maintain an isothermal or nearly isothermal temperature profile in the vessel. The main RWGS reactor vessel can be a reactor with a length longer than diameter. The entrance to the main reactor vessel can be smaller than the overall diameter of the vessel. The main reactor vessel can be a steel vessel. The steel vessel can be insulated internally to limit heat loss. Various insulations including poured or castable refractory lining or insulating bricks may be used to limit the heat losses to the environment.

A bed of catalyst can be inside the main RWGS reactor vessel. The catalyst can be in the form of granules, pellets, spheres, trilobes, quadra-lobes, monoliths, or any other engineered shape to minimize pressure drop across the reactor. In some cases, the shape and particle size of the catalyst particles is managed such that pressure drop across the reactor is between 0 and 100 pounds per square inch (psi) (345 kPa) and preferably between 0 and 20 psi. The size of the catalyst form can have a characteristic dimension of between 1 mm and 10 mm. The catalyst particle can be a structured material that is porous material with an internal surface area greater than 40 m²/g, in some cases greater than 80 m²/g with some cases having a surface area of 100 m²/g.

The RWGS catalyst can be a high-performance catalyst that is highly versatile, and which efficiently performs the RWGS reaction. The robust, solid solution transition metal catalyst can have a high thermal stability up to 800° C. and more preferably 1,100° C., does not form carbon (coking), and has good resistance to contaminants that may be present in captured CO₂ streams. This catalyst can exhibit high activity at low or no transition metal concentrations (0-20 wt. %), compared to other catalysts that require at least 30 wt. % transition metals. Furthermore, the use of expensive precious metals to enhance catalyst performance is not necessary.

In some cases, the pressure of the RWGS step and the pressure of the hydrocarbon synthesis or Liquid Fuel Production (LFP) step are within 200 psi of each other, in some cases within 100 psi of each other, and in some cases within 50 psi of each other. Operating the two processes at pressures close to each other limits the required compression of the syngas stream.

The per pass conversion of carbon dioxide to carbon monoxide in the main RWGS reactor vessel can be between 60 and 90 mole % and in some cases between 70 and 85 mole %. If an adiabatic reactor is used, the temperature in the main RWGS reactor vessel can decline from the inlet to the outlet. The main RWGS reactor vessel outlet temperature can be 50° F. to 200° F. less than the main reactor vessel inlet temperature and in some cases between 100 and 150° F. lower than the main reactor inlet temperature. The RWGS Weight Hourly Space Velocity (WHSV) which is the mass flow rate of RWGS reactants (H₂+CO₂) per hour divided by the mass of the catalyst in the main RWGS reactor bed can be between 1,000 and 50,000 hr⁻¹ and in some cases between 5,000 and 30,000 hr⁻¹.

The gas leaving the main RWGS reactor vessel is the RWGS product gas stream. The RWGS product gas comprises carbon monoxide (CO), hydrogen (H₂), unreacted carbon dioxide (CO₂), and water (H₂O). Additionally, the RWGS product gas may also comprise a small quantity of methane (CH₄) that was produced in the main reactor vessel by a side reaction.

The RWGS product gas can be used in a variety of ways at this point in the process. The product gas can be cooled and compressed and used in downstream processes to produce fuels and chemicals. The RWGS product gas can also be cooled, compressed, and sent back to the preheater and fed back to the main reactor vessel. The RWGS product gas can also be reheated in a second electric preheater and sent to a second reactor vessel where additional conversion of CO₂ to CO can occur.

With the CO (carbon monoxide) from the RWGS reaction and hydrogen from the electrolysis of water, the potential exists for useful products through the catalyst hydrogenation of carbon monoxide to hydrocarbons. The mixtures of H₂ and CO are called synthesis gas or syngas. Syngas may be used as a feedstock for producing a wide range of chemical products, including liquid fuels, alcohols, acetic acid, dimethyl ether, methanol, waxes, ammonia, and many other chemical products.

The catalytic hydrogenation of carbon monoxide to produce light gases, liquids, and waxes, ranging from methane to heavy hydrocarbons (C100 and higher) in addition to oxygenated hydrocarbons, is typically referred to Fischer-Tropsch (or F-T) synthesis. Traditional low temperature (<250° C.) F-T processes produce a high weight (or wt. %) F-T wax (C25 and higher) from the catalytic conversion process. These F-T waxes are then hydrocracked and/or further processed to produce diesel, naphtha, and other fractions. During this hydrocracking process, light hydrocarbons are also produced, which require additional upgrading to produce viable products and/or can be recycled to the eSMR unit for further conversion to syngas. The catalysts that are commonly used for F-T are either Cobalt (Co) based, or Iron (Fe) based catalysts are also active for the water gas shift (WGS) reaction that results in the conversion of feed carbon monoxide to carbon dioxide and conversion in the eSMR.

In addition to F-T, the Liquid Fuel Production (LFP) module and catalyst described herein can be used. The LFP reactor converts CO and H₂ into long chain hydrocarbons that can be used as liquid fuels and chemicals. This reactor can use a catalyst for production of liquid fuel range hydrocarbons from syngas. Syngas from syngas cooling and condensing is blended with syngas produced from the eSMR to produce an LFP reactor feed. The LFP reactor feed comprises hydrogen and carbon monoxide. Ideally the hydrogen to carbon monoxide ratio in the stream is between 1.9 and 2.2 mol/mol. The LFP reactor can be a multi-tubular fixed bed reactor system. Each LFP reactor tube can be between 13 mm and 26 mm in diameter. The length of the reactor tube is generally greater than 6 meters in length and in some cases greater than 10 meters in length. The LFP reactors are generally vertically oriented with LFP reactor feed entering at the top of the LFP reactor. However, horizontal reactor orientation is possible in some circumstances and setting the reactor at an angle may also be advantageous in some circumstances where there are height limitations.

Most of the length of the LFP reactor tube can be filled with LFP catalyst. The LFP catalyst may also be blended with diluent such as silica or alumina to aid in the distribution of the LFP reactor feed into and through the LFP reactor tube. The chemical reaction that takes place in the LFP reactor produces an LFP product gas that comprises most hydrocarbon products from five to twenty-four carbons in length (C₅-C₂₄ hydrocarbons) as well as water, although some hydrocarbons are outside this range. The LFP reactor does not typically produce any significant amount of carbon dioxide. An amount between 0% and 5% of the carbon monoxide in the LFP reactor feed is typically converted to carbon dioxide in the LFP reactor. Only a limited amount of the carbon monoxide in the LFP reactor feed is typically converted to hydrocarbons with a carbon number greater than 24. An amount between 0% and 25% of the hydrocarbon fraction of the LFP product has a carbon number greater than 24. In some cases, between 0 and 10 wgt % of the hydrocarbon fraction of the LFP product has a carbon number greater than 24; and preferably between 0 and 4 wgt % of the hydrocarbon fraction of the LFP product has a carbon number greater than 24; and even more preferably between 0 and 1 wgt % of the hydrocarbon fraction of the LFP product has a carbon number greater than 24.

As discussed above, Fischer-Tropsch (F-T) processes generally make hydrocarbon products that are from 1 to 125 carbon atoms in length. The LFP catalyst described herein does not produce heavy hydrocarbons with the same yield as other catalysts used in the F-T process. In some embodiments, the LFP catalyst has insignificant activity for the conversion of conversion of carbon monoxide to carbon dioxide via the water-gas-shift reaction. In some embodiments, the water gas shift conversion of carbon monoxide to carbon dioxide is between 0% and 5% of the carbon monoxide in the feed. In some embodiments, the LFP catalyst comprises cobalt as the active metal. In some embodiments, the LFP catalyst comprises iron as the active metal. In some embodiments, the LFP catalyst comprises combinations of iron and cobalt as the active metal. The LFP catalyst can be supported on a metal oxide support that chosen from a group of alumina, silica, titania, activated carbon, carbon nanotubes, zeolites or other support materials with sufficient size, shape, pore diameter, surface area, crush strength, effective pellet radius, or mixtures thereof. The catalyst can have various shapes of various lobed supports with either three, four, or five lobes with two or more of the lobes being longer than the other two shorter lobes, with both the longer lobes being symmetric. The distance from the mid-point of the support or the mid-point of each lobe is called the effective pellet radius which can contribute to achieving the desired selectivity to the C₅ to C₂₄ hydrocarbons. The LFP catalyst promoters may include one of the following: nickel, cerium, lanthanum, platinum, ruthenium, rhenium, gold, or rhodium. The LFP catalyst promoters are between 0 and 1 wt. % of the total catalyst and preferably between 0 and 0.5 wt. % and even more preferably between 0 and 0.1 wt. %.

The LFP catalyst support can have a pore diameter greater than 8 nanometers (nm), a mean effective pellet radius between 0 and 600 microns, a crush strength greater than 3 lbs/mm and a BET surface area of greater than 100 m²/g. The catalyst after metal impregnation can have a metal dispersion of 4%. Several types of supports can maximize the C₅-C₂₄ hydrocarbon yield. These can include alumina/silica combinations, activated carbon, alumina, carbon nanotubes, and/or zeolite-based supports.

The LFP fixed bed reactor can be operated in a manner to maximize the C₅-C₂₄ hydrocarbon yield. The LFP reactor can be operated at pressures between 150 to 450 psi. The reactor can be operated over a temperature range from 350 to 460° F. and more typically at around 410° F. The reaction is exothermic. The temperature of the reactor can be maintained inside the LFP reactor tubes by the reactor tube bundle being placed into a heat exchanger where boiling steam is present on the outside of the LFP reactor tubes. The steam temperature is at a lower temperature than the LFP reaction temperature so that heat flows from the LFP reactor tube to the lower temperature steam. The steam temperature can be maintained by maintaining the pressure of the steam. The steam is generally saturated steam. In some embodiments, the catalytic reactor can be a slurry reactor, microchannel reactor, fluidized bed reactor, or other reactor types known in the art.

The CO conversion in the LFP reactor can be maintained at between 30 to 80 mole % CO conversion per pass. CO can be recycled for extra conversion or sent to a downstream additional LFP reactor. The carbon selectivity to CO₂ can be minimized to an amount between 0% and 4% of the converted CO and more preferably between 0% and 1%. The carbon selectivity for C5-C24 hydrocarbons can be between 50 and 95%. The LFP reactor product gas contains the desired C5-C24 hydrocarbons, which are condensed as liquid fuels and water, as well as unreacted carbon monoxide, hydrogen, a small amount of C1-C4 hydrocarbons (which are recycled to the eSMR for additional syngas production), and a small amount of C24+ hydrocarbons (which also may be recycled for additional syngas production). The desired product can be separated from the stream by cooling, condensing the product and/or distillation or any other acceptable means. The unreacted carbon monoxide, hydrogen, and C1-C4 hydrocarbons can be part of the feed to the electrified steam-methane-reforming (eSMR) reactor.

In the eSMR, the eSMR hydrocarbon feed comprises carbon monoxide, carbon dioxide, hydrogen, and C1-C5 hydrocarbons. Steam/water is added to the eSMR to facilitate the reforming process.

The gas mixture produced by the LFP system is cooled via air coolers and sent to a three-phase separator. Condensed water is knocked out and sent to water treatment prior to reuse. The light gases produced in the LFP (tail gas) are separated in, with one stream being recycled to the LFP and the other sent to the steam-methane reformer (eSMR) for production of syngas. The eSMR produces a hydrogen rich syngas stream due to the presence of steam/water in the system that is an input from a number of points in the integrated system where excess steam/water exists and/or from a freshwater feed. This approach produces enough excess hydrogen such that the size of the electrolyzer in the system may be reduced such that capital costs are reduced by 5%, 10%, 25%, or at times up to 40% of the electrolyzer system. The liquefied fuel produced from the LFP is then pumped to 6 barg. The distillation column produces two or more cuts of fuel. The principal product is diesel fuel which is then cooled and pumped to storage where it is stored at ambient conditions. The secondary product is naphtha which is then pumped and sent to a naphtha stabilizer column with a bottoms RVP of 8 psia. The stabilized naphtha is then cooled to 120° F. and sent to storage. In some embodiments, further treatment of naphtha and diesel via light isomerization enables the production of a high percentage of sustainable aviation fuel or SAF.

The heat (in the form of steam) required for the distillation and naphtha stabilization process is produced in the RWGS, eSMR, and liquid fuel production (LFP) systems.

Tail gas produced in the LFP and separated in a three-phase separator is compressed to 27 bar and preheated in a cross-exchanger. It is then combined with steam of the same pressure and run through a pre-reformer to convert C₂₊ hydrocarbons to methane. The stream is then electrically heated and sent through the eSMR to produce additional syngas. The produced syngas is cooled via a process boiler or boilers producing high pressure steam and a cross-exchanger to 360° F. The cooled syngas is then further air cooled. The syngas is then recycled to LFP unit, and the condensate is sent to water treatment.

In some embodiments, the eSMR hydrocarbon feed comprises the unreacted carbon monoxide, hydrogen, and generally C1-C4 hydrocarbons although some higher hydrocarbons may exist in the steam. In some cases, the eSMR feed comprises some fraction of the oxygen gas produced by electrolysis. In some cases, the feed also comprises natural gas or other light hydrocarbons including some of the naphtha produced from the LFP process. The natural gas comprises methane and may contain light hydrocarbons as well as carbon dioxide. In some embodiments, the fuel and chemicals produced may not be zero carbon fuels but will still have an improved carbon intensity over traditional fuels and chemicals. In some embodiments, the fuel and chemicals produced may be negative carbon fuels or chemicals. The eSMR feed can be converted to syngas (including a large percentage of hydrogen). This can reduce the amount of water that needs to be electrolyzed to produce hydrogen and reduces the size of the electrolyzer, which reduces capital and operating costs of the electrolyzer. In the eSMR hydrocarbon feed, the ratio of natural gas to LFP unreacted carbon monoxide, hydrogen, and C1-C4 hydrocarbons (or greater) can be an amount between 0 kg/kg and 2.0 kg/kg, and more preferably an amount between 0 kg/kg and 1.25 kg/kg.

The eSMR can produce a product that is high in carbon monoxide. The carbon dioxide in the product gas can be an amount between 0 mol % and 10 mol %. The eSMR oxidant feed can comprise steam and oxygen where the oxygen is produced by the electrolysis of water and steam can come from various streams in the system. The eSMR oxidant feed and the eSMR hydrocarbon feed can be preheated and then reacted in an eSMR burner where the oxidant and the hydrocarbon are partially oxidized at temperatures in the burner of greater than 2000° C. The eSMR reactor can be divided into a plurality of zones. First, the eSMR reactor contains vertical tubes which contain a catalyst. Suitable eSMR catalysts for the catalytic zone reactions are typically nickel based. The novel solid solution catalyst described herein can be used as an eSMR catalyst. Other suitable eSMR catalysts are nickel on alpha phase alumina or magnesium alumina spinel (MgAl₂O₄) with or without precious metal promoters. The precious metal promoter can comprise gold, platinum, rhenium, or ruthenium. Spinels can have a higher melting point and a higher thermal strength and stability than the alumina-based catalysts. In another embodiment, the eSMR catalyst is a solid solution catalyst that has high resistance to coking and can process gas feed streams that have high CO2 content. The heating zones, where more heat can be added to where the eSMR requires the most heat for the highest endothermic part of the reaction. In some embodiments the heating elements are clam shell heaters around tubes. In other embodiments, the heating elements are curved heaters on the front and back of the tubes. In other embodiments the heating elements are starbar type headers strategically placed in the can. Starbar type heaters are cylindrical heaters that can be placed vertically or horizontally near the desired area where heat is needed and that provide heat similarly to the profile that might be produced from gas fired heating. In other embodiments, the heating element is a high temperature heat trace. In other embodiments, the heating element includes clam shell type heaters positioned around steam reforming tubes.

The thermal zone is where thermal reactions occur. There are numerous ways that the electrical heating of the feed gas can be done. One way is using an electrically heated radiant furnace. In this embodiment, at least a portion of the feed gas passes through a heating coil in a furnace. In the furnace, the heating coil is surrounded by radiant electric heating elements. In another embodiment of the invention, the gas is passed directly over heating elements whereby the gas is heated by convective heat transfer. The electric heating elements can be made from numerous materials. The most common heating elements are nickel chromium alloys. These elements may be in rolled strips or wires or cast as zig zag patterns. The elements are fixed into an insulated vessel where ceramic fiber is generally used for insulation. The radiant elements may be divided into zones to give a controlled pattern of heating. Multiple coils and multiple zones may be needed to provide the energy to produce a heated feed gas. Radiant furnaces require proper design of the heating elements and fluid coils to ensure good view factors and good heat transfer. The electricity usage by the radiant furnace should be as low as possible.

The main overall reactions in the thermal zone can include the homogeneous gas-phase steam hydrocarbon reforming and the shift reaction. In the catalytic zone, the final conversion of hydrocarbons takes place through heterogeneous catalytic reactions including steam methane reforming and water gas shift reaction. The resulting eSMR product gas can have a composition that is close to the predicted thermodynamic equilibrium composition. The actual eSMR product gas composition can be the same as the thermodynamic equilibrium composition within a difference of an amount between 0° C. and 70° C. This is the so-called equilibrium approach temperature. To keep the amount of CO₂ produced in the eSMR to a minimum, the amount of steam in the eSMR oxidant feed can be kept as low as possible. This can still result in a low soot eSMR product gas that is close to the equilibrium predicted composition. Typically, the total steam to carbon ratio (mol/mol) in the combined eSMR feed (oxidant+hydrocarbon) can be between 0.4 to 1.0, with the optimum being around 0.6. As the steam to carbon ratio in the eSMR feed increases, the H₂/CO ratio in the syngas increases. The amount of carbon dioxide also increases. In some embodiments, changing or adjusting the steam to carbon ratio can be beneficial to control the amount of overall hydrogen production in the facility.

The eSMR product can leave the eSMR catalytic zone at temperatures more than 800° C. The eSMR product can be cooled to lower temperatures through a waste heat boiler where the heat is transferred to generate steam. This steam, as well as the lower pressure steam produced by the LFP reactor, can be used to generate electricity.

The eSMR product can be blended with the RWGS product and be used as LFP reactor feed. This can result in a high utilization of the original carbon dioxide to C5 to C24 hydrocarbon or other desired PtX products. In some embodiments, the carbon number distribution is shorter or longer depending upon plant design and operating conditions.

In some embodiments, the LFP product gas is not suitable as a direct feed to the eSMR and must be pre-reformed. A pre-reformer is designed to convert heavy hydrocarbons into lighter hydrocarbons and typically methane is a main constituent of the pre-reformer product gas. The main purpose is reducing the amount of heavy hydrocarbons that go into the eSMR. The pre-reformer process typically involves a series of reactions in which the heavy hydrocarbons are partially cracked and reformed with steam to produce lighter hydrocarbons such as methane. The pre-reformer is operated at high temperatures and pressures using a catalyst system. The catalyst system comprises metals including cobalt, iron, and platinum as the base metal and support materials comprising silica and alumina.

The LFP product gas comprising the unreacted carbon monoxide, hydrogen, C1-C4 (or greater) hydrocarbons and CO2 comprise the pre-reformer hydrocarbon feed gas. In other embodiments, some wax and/or light liquid products are included in the pre-reformer feed. This scenario may be used when production of middle distillate products including diesel and SAF/kerosene/jet fuel are desired. The higher the higher hydrocarbons and carbon oxides in the stream may require the use of a pre-reformer instead of directly being used in as eSMR hydrocarbon feed. The pre-reformer is generally an adiabatic reactor. The adiabatic pre-reformer converts higher hydrocarbons in the pre-reformer feed into a mixture of methane, steam, carbon oxides and hydrogen that are then suitable as eSMR hydrocarbon feed. One benefit of using a pre-reformer is that it enables higher eSMR hydrocarbon feed pre-heating that can reduce the oxygen, if this is used as a feed, in the eSMR. The resulting integrated process as described above results in high conversion of carbon dioxide to C5-C24 hydrocarbon products or other PtX products that are suitable as fuels or chemicals.

In some embodiments, an eSMR process that converts the tail gas (and potentially other hydrocarbon feedstocks) from the fuel/chemical production stage and optionally oxygen from the electrolysis processes into additional syngas. In some embodiments, the use of heat energy from the eSMR process for operation of the (CO₂) RWGS (hydrogenation) catalyst. In some embodiments, the separation and conversion of the CO₂ from the eSMR process into additional syngas using the CO2 hydrogenation catalyst. In some embodiments, a RWGS catalyst, reactor, and process converts CO₂ and hydrogen into syngas and operating this RWGS operation at a pressure that is close to the pressure of the fuel/chemical production process, which converts the syngas into fuels or chemicals. In some cases, these fuels or chemicals are paraffinic or olefinic hydrocarbon liquids with a majority being in the C5-C24 range.

The systems and methods described herein can utilize a sensor. The sensor can be a flowrate sensor, a sensor that detects the chemical composition of a process stream, a temperature sensor, a pressure sensor, or a sensor coupled to the price or availability of a process input, such as CO₂ or electrical power.

In an aspect, the systems and methods described herein efficiently capture and utilize carbon dioxide and convert it into useful products such as fuels (e.g., diesel fuel, gasoline, gasoline blendstocks, jet fuel, kerosene, other) and chemicals (e.g., solvents, olefins, alcohols, aromatics, lubes, waxes, ammonia, methanol, other) that can displace fuels and chemicals produced from fossil sources such as petroleum and natural gas. This can lower the total net emissions of carbon dioxide into the atmosphere. Zero carbon, low carbon, or ultra-low carbon fuels and chemicals have minimal fossil fuels combusted in the process. In some cases, any heating of the feeds to the integrated process is done by indirect means (e.g., cross exchangers) or via electric heating where the electricity comes from a zero carbon or renewable source such as wind, solar, geothermal, or nuclear.

### CERTAIN EMBODIMENTS

The following are certain embodiment of processes for the conversion of carbon dioxide, water, and renewable electricity into low or zero carbon high quality fuels and chemicals:

1. Water is fed into an electrolysis system powered using renewable electricity to produce hydrogen and oxygen. Carbon dioxide is captured from a source. The carbon dioxide is mixed with hydrogen from the electrolysis system to form a stream (Reverse Water Gas Shift feedstock or “RWGS” feedstock) that is heated and fed into an RWGS reactor vessel that includes a RWGS catalyst. The RWGS reactor converts the feedstock to an RWGS product gas comprising carbon monoxide, hydrogen, unreacted carbon dioxide and water. In response to a stimulus of an increase in the cost of renewable electricity, the amount of power supplied to the electrolysis system is reduced. To compensate for the reduced production of hydrogen, a controller activates a hydrogen recovery module which recovers hydrogen from the RWGS product gas and recycles it to the RWGS reactor. This compensation maintains the ratio of hydrogen and carbon dioxide between 2.0 and 4.0. The RWGS product gas is cooled, compressed, and fed into a Liquid Fuels Production (“LFP”) system. The LFP system converts RWGS product gas into hydrocarbon products, where more than 51 mole percent of the products are C5 to C24 hydrocarbons.

2. Water is fed into an electrolysis system powered using renewable electricity to produce hydrogen and oxygen. Carbon dioxide is captured from a fermentation exhaust. The carbon dioxide is mixed with the hydrogen from the electrolysis system to form a stream (Reverse Water Gas Shift feedstock or “RWGS” feedstock) that is heated and fed into a RWGS reactor vessel that includes an RWGS catalyst. The RWGS reactor converts the feedstock to an RWGS product gas comprising carbon monoxide, hydrogen, unreacted carbon dioxide and water. In response to a stimulus of an increase in the cost of renewable electricity, the amount of power supplied to the electrolysis system is reduced. To compensate for the reduced production of hydrogen, additional hydrogen is drawn from a pipeline or hydrogen storage vessel. This compensation maintains the ratio of hydrogen and carbon dioxide between 2.0 and 4.0. The RWGS product gas is cooled, compressed, and fed into a Liquid Fuels Production (“LFP”) system. The LFP system converts RWGS product gas into hydrocarbon products, where more than 50 percent of the products are C5 to C24 hydrocarbons.

3. Water is fed into an electrolysis system powered using renewable electricity to produce hydrogen and oxygen. Carbon dioxide is captured from a source. The carbon dioxide is mixed with hydrogen from the electrolysis system to form a stream (Reverse Water Gas Shift feedstock or “RWGS” feedstock) that is heated and fed into a RWGS reactor vessel that includes a RWGS catalyst. The RWGS reactor converts the feedstock to an RWGS product gas comprising carbon monoxide, hydrogen, unreacted carbon dioxide and water. In response to a stimulus of an increase in the cost of renewable electricity, the amount of power supplied to the electrolysis system is reduced. To compensate for the reduced production of hydrogen, a controller activates a hydrogen recovery module which recovers hydrogen from the RWGS product gas and recycles it to the RWGS reactor. This compensation maintains the ratio of hydrogen and carbon dioxide between 2.0 and 4.0. The RWGS product gas is cooled, compressed, and fed into a Liquid Fuels Production (“LFP”) system. The LFP system converts RWGS product gas into hydrocarbon products, where more than 50 percent of the products are C5 to C24 hydrocarbons. Additionally, one or more C1-C4 (or greater) hydrocarbons, carbon monoxide and hydrogen are fed into a pre-reformer and then into an eSMR reactor that includes a catalyst to provide an eSMR product stream. The RWGS product gas is blended with the eSMR product stream and fed into a Liquid Fuels Production (“LFP”) system to increase the productivity of the system. Optionally additional naphtha and/or wax products are fed to the pre-reformer and then the eSMR to increase the volume of eSMR product steam.

Suitable catalysts for the eSMR are typically nickel based. Other suitable catalysts are nickel on alpha phase alumina, or magnesium alumina spinel (MgAl₂O₄), which are used with or without precious metal promoters where the precious metal promoter comprises gold, platinum, rhenium, or ruthenium. Spinels have a higher melting point, higher thermal strength, and higher stability than alumina-based catalysts.

4. Water is fed into an electrolysis system powered using renewable electricity to produce hydrogen and oxygen. Carbon dioxide is captured from a source. The carbon dioxide is mixed with the hydrogen from the electrolysis system to form a stream (Reverse Water Gas Shift feedstock or “RWGS” feedstock) that is heated and fed into a RWGS reactor vessel that includes an RWGS catalyst. The RWGS reactor converts the feedstock to an RWGS product gas comprising carbon monoxide, hydrogen, unreacted carbon dioxide and water. A sensor detects that the ratio of hydrogen to carbon dioxide is below 2.5 and sends a signal to a controller which activates a hydrogen recovery module which recovers hydrogen from the RWGS product gas and recycles it to the RWGS reactor. This compensation maintains the ratio of hydrogen and carbon dioxide between 2.0 and 4.0. The RWGS product gas is cooled, compressed, and fed into a Liquid Fuels Production (“LFP”) system. The LFP system converts RWGS product gas into hydrocarbon products, where more than 50 percent of the products are C5 to C24 hydrocarbons.

5. Water is fed into an electrolysis system powered using renewable electricity to produce hydrogen and oxygen. Carbon dioxide is captured from a source. The carbon dioxide is mixed with the hydrogen from the electrolysis system to form a stream (Reverse Water Gas Shift feedstock or “RWGS” feedstock) that is heated and fed into a RWGS reactor vessel that includes a RWGS catalyst. The RWGS reactor converts the feedstock to an RWGS product gas comprising carbon monoxide, hydrogen, unreacted carbon dioxide and water. In response to a stimulus of an increase in the cost of renewable electricity, the operating temperature of the RWGS reactor is reduced, thereby consuming less power. This modification alters the product composition from the RWGS reactor. The RWGS product gas is cooled, compressed, and fed into a Liquid Fuels Production (“LFP”) system. The LFP system converts RWGS product gas into hydrocarbon products, where more than 50 percent of the products are C5 to C24 hydrocarbons.

6. Water is fed into an electrolysis system powered using renewable electricity to produce hydrogen and oxygen. Carbon dioxide is captured from a source. The carbon dioxide is mixed with the hydrogen from the electrolysis system to form a stream (Reverse Water Gas Shift feedstock or “RWGS” feedstock) that is heated and fed into a RWGS reactor vessel that includes an RWGS catalyst. The RWGS reactor converts the feedstock to an RWGS product gas comprising carbon monoxide, hydrogen, unreacted carbon dioxide and water. In response to a stimulus of a reduced supply of renewable electricity, the amount of power supplied to the electrolysis system is reduced, but the power supplied to other modules of the system is substantially maintained. The RWGS product gas is cooled, compressed, and fed into a Liquid Fuels Production (“LFP”) system. The LFP system converts RWGS product gas into hydrocarbon products, where more than 50 percent of the products are C5 to C24 hydrocarbons.

The above-described embodiments can be implemented in any of numerous ways. For example, the embodiments may be implemented using hardware, software, or a combination thereof. When implemented in software, the software code can be executed on any suitable processor or collection of processors, whether provided on a single computer or distributed among multiple computers. It should be appreciated that any component or collection of components that perform the functions described above can be generically considered as one or more controllers that control the above-discussed functions. The one or more controllers can be implemented in numerous ways, such as with dedicated hardware or with one or more processors programmed using microcode or software to perform the functions recited above.

In this respect, it should be appreciated that one implementation of the embodiments of the present invention comprises at least one non-transitory computer-readable storage medium (e.g., a computer memory, a portable memory, a compact disk, etc.) encoded with a computer program (i.e., a plurality of instructions), which, when executed on a processor, performs the above-discussed functions of the embodiments of the present invention. The computer-readable storage medium can be transportable such that the program stored thereon can be loaded onto any computer resource to implement the aspects of the present invention discussed herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

Various aspects of the present invention may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments.

Also, embodiments of the invention may be implemented as one or more methods, of which an example has been provided. The acts performed as part of the method(s) may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having the same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and the equivalents thereto.

The following Example is for illustrative purposes and is not in any way meant to limit the scope of the invention.

Example: For this example, there is a Hydrogen Recovery Module as shown in FIG. 2. In this example, electricity is reduced by 50% for a 12-hour period. The monitor and controller are used to moderate the feedstocks. In this case, the Hydrogen Recovery Module responds to the stimulus by separating H₂ from the RWGS reactor outlet which also includes syngas from eSMR and recycles H₂ back to RWGS inlet to keep H₂/CO₂ ratio in the feed the same. CO₂ usage stays the same. Water to the eSMR is increased resulting in a higher steam to carbon ratio resulting in a higher H2/CO leaving the eSMR. The H2/CO ratio to the LFP decreases from 2.0 to 1.8 (say). The overall LFP reactor conversion declines by 20 relative percent from the pre-stimulus base case. The overall decrease in product leaving the facility is declined by 20% instead of a 50% decrease and showing the benefit of the invention. Therefore, the overall plant revenue increases by 20% for the 12-hour period. This represents a substantial improvement in revenue over the base case.

In this example, there is a Hydrogen Recovery Module as shown in FIG. 2. Electricity is reduced by 50% for a 12-hour period. The monitor and controller are used to moderate the feedstocks. In this case, the Hydrogen Recovery Module responds to the stimulus by separating H₂ from the RWGS reactor outlet which also includes syngas from eSMR and recycles H₂ back to RWGS inlet to keep H₂/CO₂ ratio in the feed the same. CO₂ usage stays the same. Water to the eSMR is increased resulting in a higher steam to carbon ratio resulting in a higher H₂/CO leaving the eSMR. The H₂/CO ratio to the LFP decreases from 2.0 to 1.8. The overall LFP reactor conversion declines by 20% relative percent from the pre-stimulus base case. The overall decrease in product leaving the facility is declined by 20% instead of a 50% decrease that would happen without the response to the stimuli which showing one of the benefits of the invention. Therefore, the overall plant revenue increases by 15 to 40% for the 12-hour period versus the case where there is no response to the stimuli. This represents a substantial improvement in revenue over the base case/no response.

1. A process for producing liquid hydrocarbons, wherein the process comprises:
a. converting water into an electrolysis product stream comprising H₂ using an electrolysis module powered by an amount of electricity;
b. reacting CO₂ with the electrolysis product stream in a reverse water gas shift module to produce a first synthesis gas mixture comprising CO and H₂;
c. converting the first synthesis gas mixture into a product mixture using a hydrocarbon synthesis module, wherein the product mixture comprises liquid hydrocarbons, light gases, and water, and wherein the liquid hydrocarbons comprise C5-C24 hydrocarbons, and the light gases comprise C1-C4 hydrocarbons and unreacted CO and H₂;
d. separating the liquid hydrocarbons from the water and the light gases;
e. feeding the light gases to an electrified steam-methane-reforming reactor to produce a second synthesis gas mixture comprising CO and H₂;
f. feeding the second synthesis gas mixture back to the hydrocarbon synthesis module
thereby producing additional liquid hydrocarbons.

2. The process according to claim 1, wherein the feeding of the second synthesis gas mixture back to the hydrocarbon synthesis module reduces the amount of electricity used to power the electrolysis module.

3. The process according to claim 1, wherein the liquid hydrocarbons are distilled to provide a primary liquid hydrocarbon product and a secondary product, wherein the primary liquid hydrocarbon product is diesel fuel, and the secondary product is naphtha.

4. The process according to claim 1, wherein the electrified steam-methane reforming reactor comprises vertical tubes comprising a catalyst, and wherein the catalyst comprises nickel.

5. The process according to claim 1, wherein the light gases are pre-reformed using a pre-reformer before being fed into the electrified steam-methane-reforming reactor.

6. The process according to claim 1, wherein the light gases are heated using an electrically heated radiant furnace before being fed into the electrified steam-methane-reforming reactor.

7. The process according to claim 1, wherein the electrolysis product stream comprising H₂ is stored, and wherein the electrolysis product stream is fed to the reverse water gas shift module upon receipt of a stimulus.

8. The process according to claim 1, wherein the electrolysis module comprises a solid oxide electrolysis electrolyzer.

9. The process according to claim 2, wherein the amount of electricity used to power the electrolysis module is reduced in an amount ranging from five percent to forty percent.

10. The process according to claim 1, wherein the liquid hydrocarbons are 51-100 mol % C5-C24 hydrocarbons.

11. The process according to claim 10, wherein the liquid hydrocarbons are 60-100 mol % C5-C24 hydrocarbons.

12. The process according to claim 11, wherein the liquid hydrocarbons are 80-100 mol % C5-C24 hydrocarbons.

13. A system for producing liquid hydrocarbons, wherein the system comprises: an electrolysis module comprising an electrolyzer for converting water into an electrolysis product stream; a reverse water gas shift module operably connected to the electrolysis module for producing a first synthesis gas mixture; a hydrocarbon synthesis module operably connected to the reverse water gas shift module for producing a hydrocarbon product mixture; a separation unit operably connected to the hydrocarbon synthesis module for separating components of the hydrocarbon mixture; an electrified steam-methane-reforming reactor operably connected to the separation unit for producing a second synthesis gas mixture; an operable connection from the electrified steam-methane-reforming reactor so that the second synthesis gas mixture can be fed back to the hydrocarbon synthesis module.

14. The system according to claim 13, wherein the electrified steam-methane-reforming reactor comprises vertical tubes comprising a catalyst, and wherein the catalyst comprises nickel.

15. The system according to claim 13, wherein the system further comprises a storage operably connected to electrolysis module and the reverse water gas shift water module for storage of the electrolysis product stream.

16. The system according to claim 13, wherein the electrolyzer is a solid oxide electrolysis electrolyzer.

17. The system according to claim 13, wherein the electrolyzer is powered by an amount of electricity, and wherein the operable connection between the electrified steam-methane-reforming reactor and the electrolysis module provides for a five percent to forty percent reduction in the amount of electricity powering the electrolyzer.
